(19) United States
(12) Patent Application Publication
(10) Pub. No.: US 2014/0137345 A1
(43) Pub. Date: May 22, 2014

(54) INFECTED DENTAL IMPLANT CLEANING TECHNIQUE

(71) Applicant: HANS KOREA CO., LTD, Seoul (KR)

(72) Inventor: Han Chip KIM, Seoul (KR)

(73) Assignee: HANS KOREA CO., LTD, Seoul (KR)

(21) Appl. No.: 14/164,159

(22) Filed: Jan. 25, 2014

Related U.S. Application Data
(63) Continuation-in-part of application No. 13/519,130, filed on Jun. 25, 2012.

(51) Int. Cl. A61C 17/00; A61C 8/00

(52) U.S. Cl. CPC A61C 17/036; A61C 8/0089
USPC 15/22.1; 15/160

(57) ABSTRACT

A dental implant cleaning apparatus includes: a wire bundle formed of flexible materials; a tube enclosing the wire bundle; and a driver connected to the wire bundle, to drive the wire bundle. Accordingly, a clean dental implant may be maintained after the dental implant is placed, and a lifespan of an implant may be extended by mechanically removing chemical and biological infections (pollutants) from a surface of the implant when the implant is infected.

### TECHNICAL FIELD

The present invention relates to a dental implant cleaning apparatus, and more particularly, to an apparatus for mechanically cleaning a surface of a dental implant that is required to be cleaned due to infection and the like.

### BACKGROUND ART

In general, an implant refers to a substitute to restore a lost tissue of a human body. In a dental clinic, the implant refers to a substitute to enable an original function of a tooth to be restored by inserting a fixture in an alveolar bone, from which a natural tooth root is separated, by adhering the fixture, and by fixing an artificial tooth, so that the substitute may function as a lost tooth root.

After a dental implant is placed in a gum, a surface or the dental implant or a circumference of the dental implant may be contaminated by biological and chemical materials, such as bacteria and the like, due to chemical and biological pollutants, such as food scraps and the like, stuck in the dental implant, or other issues, and such a contamination may contribute to or be called “infection.” Since there is a great concern about spreading of the infection to the entire alveolar bone when the infection is left untreated, pollutants attached on the surface of the implant need to be removed. However, pollutants are adhered to materials coated on the surface of the implant, to promote osseointegration of the implant, and as a result both the coated materials and pollutants need to be removed. Pollutants have been removed by a chemical method (drug injection); however, a need for mechanical cleaning is proposed due to many limits on chemical cleaning.

### DISCLOSURE OF INVENTION

### Technical Goals

An aspect of the present invention is to provide a dental implant cleaning apparatus for effectively removing chemical and biological pollutants existing in an infected or polluted dental implant.

Another aspect of the present invention is to effectively remove chemical and biological pollutants on a surface of a dental implant, while minimizing damage on a shape of the dental implant.

### Technical Solutions

According to an aspect of the present invention, there is provided a dental implant cleaning apparatus, including: a wire bundle formed of flexible materials with strong resiliency; a tube enclosing the wire bundle; and a driver connected to the wire bundle, to drive the wire bundle.

According to another aspect of the present invention, a dental implant cleaning apparatus may enable a wire formed of Ni—Ti materials to be in contact with a dental implant, and may remove chemical and biological pollutants existing in the dental implant.

According to still another aspect of the present invention, there is provided a dental implant cleaning apparatus including: a driving shaft: an implant receiving portion driven integrally with the driving shaft, to receive an implant; and a brush connected to the implant receiving portion and including a wire bundle protruding inwards from the implant receiving portion.

### Effect of Invention

According to embodiments of the present invention, it is possible to maintain a clean dental implant after the dental implant is placed, and is possible to remove (treat) pollutants attached on an implant, instead of removing the implant from a gum, when the implant is already contaminated.

Additionally, according to embodiments of the present invention, it is possible to cleanly clean a dental implant, without significantly damaging on a basic shape of the dental implant.

### BRIEF DESCRIPTION OF DRAWINGS

FIG. 1 is a perspective view of a dental implant cleaning apparatus according to a first embodiment of the present invention.

FIG. 2 is a diagram of an operation state of the dental implant cleaning apparatus according to the first embodiment of the present invention.

FIG. 3 is a perspective view of an example of two wire bundles in a dental implant cleaning apparatus according to a second embodiment of the present invention.

FIG. 4 is a perspective view of an example of three wire bundles in the dental implant cleaning apparatus according to the second embodiment of the present invention.

FIG. 5 is a perspective view of an example of one wire bundle in the dental implant cleaning apparatus according to the second embodiment of the present invention.

FIG. 6a is a diagram illustrating an internal structure of the dental implant cleaning apparatus according to the second embodiment of the present invention.

FIG. 6b is a front view of an example of a wire insertion portion in the dental implant cleaning apparatus according to the second embodiment of the present invention.

FIG. 7 is a perspective view of a dental implant cleaning apparatus according to a third embodiment of the present invention.

FIG. 8 is a perspective view illustrating an internal structure of the dental implant cleaning apparatus according to the third embodiment of the present invention.

FIG. 9 is an exploded perspective view of the dental implant cleaning apparatus according to the third embodiment of the present invention.

FIG. 10 is a diagram illustrating an operation state of the dental implant cleaning apparatus according to the third embodiment of the present invention.

FIG. 11 is an exploded perspective view of a dental implant cleaning apparatus according to a fourth embodiment of the present invention.

FIG. 12 is an exploded perspective view of a dental implant cleaning apparatus according to a fifth embodiment of the present invention.

FIGS. 13a and 13b are diagrams illustrating wires used in the dental implant cleaning apparatus according to the fifth embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

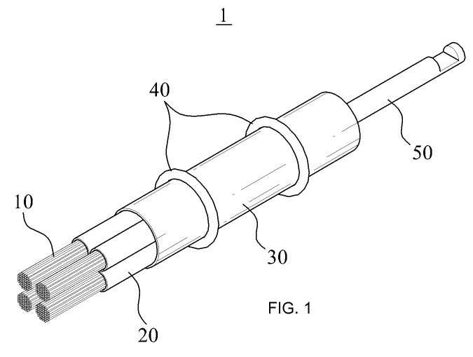

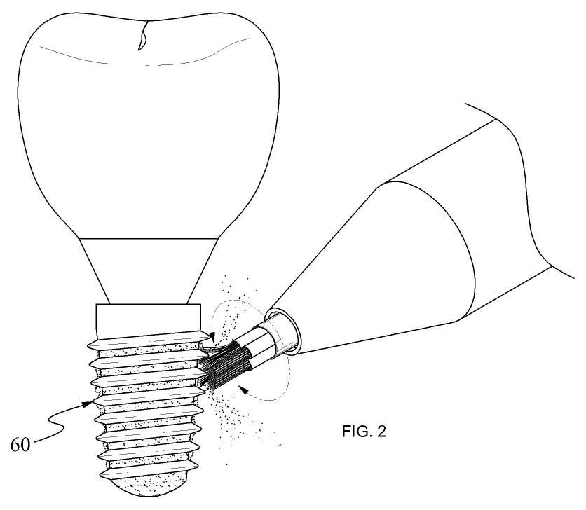

FIG. 1 is a perspective view of a dental implant cleaning apparatus according to a first embodiment of the present invention, and FIG. 2 is a diagram of an operation state of the dental implant cleaning apparatus according to the first embodiment of the present invention.

Referring to FIGS. 1 and 2, a dental implant cleaning apparatus 1 according to the first embodiment of the present invention may include a wire bundle 10, a tube 20, a driver body 30, an O-ring 40, and a shaft 50.

The wire bundle 10 may include a plurality of wires. The wires may be formed of bendy and flexible materials, or metal materials having elasticity. The wires may desirably be formed of shape-memory alloys, such as nickel-titanium (Ni—Ti) alloys, and the like.

The wire bundle 10 may be in direct contact with a dental implant, and may scrap food scraps, pollutants, and the like that exist in an outer circumference of a dental implant 60. Additionally, the wires may each have a diameter of about 1 nm (0.05 mm˜0.1 mm), and may be very small and long. Accordingly, the wires may easily remove remnants that deeply exist in a screw thread of the dental implant 60, for example.

In addition, since the wire bundle 10 is formed of bendy and flexible materials, the outer circumference of the dental implant 60 may be hardly damaged when the wires are in contact with the outer circumference of the dental implant 60.

The tube 20 may enclose the wire bundle 10. The tube 20 may have a cylindrical shape, and a space, in which the wire bundle 10 is to be inserted, may be formed in the tube 20.

The tube 20 may collect wires in the wire bundle 10 to prevent the wires from being dispersed. The tube 20 may be formed of stainless steel with excellent strength and corrosion resistance.

The driver body 30 may be connected to the wire bundle 10, and may enable the wire bundle 10 to rotate or vibrate.

In the present embodiment, the driver body 30 may be rotated, however, the driver body 30 may be vibrated by an engine and the like that enables ultrasonic vibration.

In the driver body 30, four wire bundles 10 may be arranged at intervals of 90°, as shown in FIG. 1, or three wire bundles may be arranged at intervals of 120°.

To prevent the wire bundle 10 from being separated from the driver body 30, the O-ring 40 may be used. A groove may be formed in a side of the driver body 30, and the O-ring 40 may be inserted into the groove. A hole may be formed in the groove.

The O-ring 40 may be inserted into the groove and may apply pressure to the wire bundle 10 through the hole, to prevent the wire bundle 10 from being separated from the driver body 30, and to fix the wire bundle 10 in the driver body 30.

Alternatively, when the driver body 30 is formed of materials that may be transformed by external pressure, for example rubber and the like, a hole may not need to be formed in a side of the driver body 30 to prevent separation of the wire bundle 10.

This is because, when the driver body 30 is easily transformable by external pressure, when the driver body 30 is enclosed by the O-ring 40, the wire bundle 10 may be prevented from being separated from the driver body 30 by applying pressure to the wire bundle 10 while the driver body 30 is transformed.

The O-ring 40 may be formed of materials having elasticity, for example rubber and the like, and may enclose an outer circumference of the driver body 30.

The shaft 50 may be connected to an end portion of the driver body 30, to enable the driver body 30 to rotate or vibrate. The shaft 50 may extend from the driver body 30, and may be connected to an electromotor, such as a motor and the like, or to an engine and the like that enables ultrasonic vibration.

In the present embodiment, the shaft 50 may enable the driver body 30 to rotate, however, the shaft 50 may be vibrated by an engine and the like that enables ultrasonic vibration, and may enable the driver body 30 to vibrate by transferring such vibration to the driver body 30.

Hereinafter, an operation of the dental implant cleaning apparatus according to the present embodiment will be described.

The wire bundle 10 may be enclosed using the tube 20. The wire bundle 10 enclosed by the tube 20 may be inserted into the driver body 30.

In a state in which the wire bundle 10 is inserted into the driver body 30, the outer circumference of the driver body 30 may be enclosed by the O-ring 40, and the wire bundle 10 may be fixed in the driver body 30.

In a state in which the wire bundle 10 is fixed in the driver body 30, the shaft 50 may be rotated (or vibrated). When the shaft 50 is rotated (or vibrated), the wire bundle 10 connected to the driver body 30 may be rotated (or vibrated). When the rotated (or vibrated) wire bundle 10 comes in contact with the dental implant 60, the wire bundle 10 that is being rotated (or vibrated) may be in contact with remnants stuck in the outer circumference of the dental implant 60, and may remove the remnants.

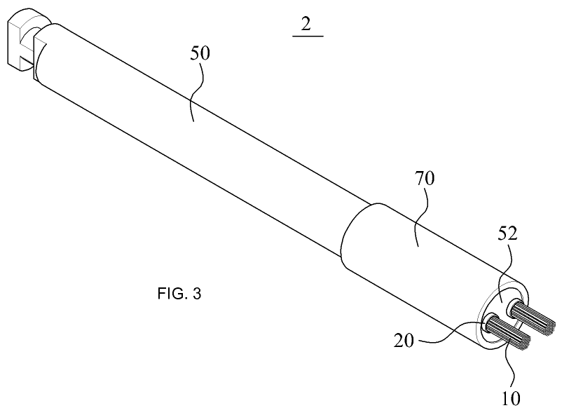

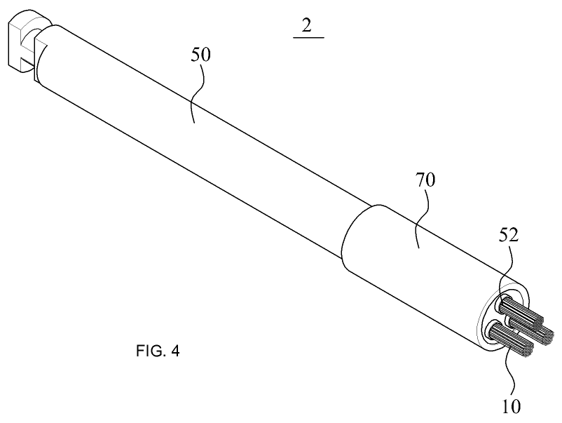

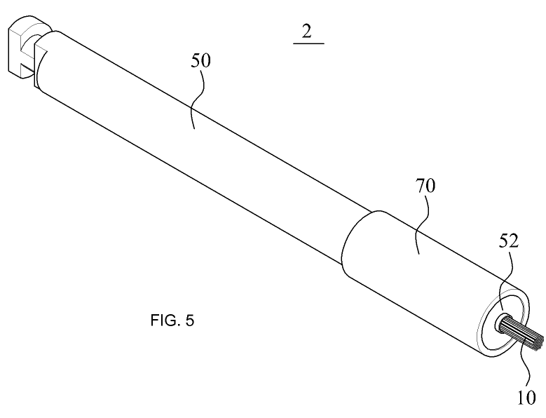

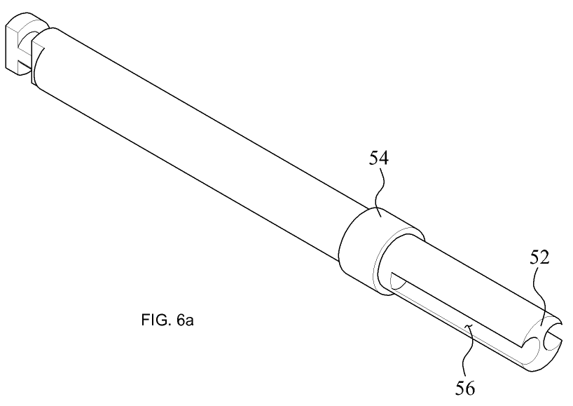

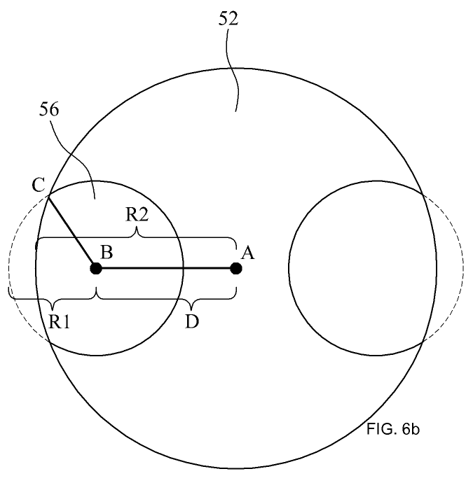

FIG. 3 is a perspective view of a dental implant cleaning apparatus according to a second embodiment of the present invention, FIG. 4 is a perspective view of an example of three wire bundles in the dental implant cleaning apparatus according to the second embodiment of the present invention, FIG. 5 is a perspective view of an example of one wire bundle in the dental implant cleaning apparatus according to the second embodiment of the present invention, FIG. 6a is a diagram illustrating an internal structure of the dental implant cleaning apparatus according to the second embodiment of the present invention, and FIG. 6b is a front view of an example of a wire insertion portion in the dental implant cleaning apparatus according to the second embodiment of the present invention.

Referring to FIGS. 3 through 6b, a dental implant cleaning apparatus 2 according to the present embodiment may include a shaft 50, a wire insertion portion 52 formed in one end of the shaft 50, and a cover 70 to fix a wire bundle 10 in the wire insertion portion 52.

The wire insertion portion 52 may be formed integrally with the shaft 50, or may be connected as a separate part to the shaft 50 if necessary. The wire insertion portion 52 may have a cylindrical shape, and an insertion groove 56, in which the wire bundle 10 is to be inserted, may be formed in the wire insertion portion 52. The insertion groove 56 may have a cylindrical shape.

The insertion groove 56 may be formed to be long along a length of the wire insertion portion 52, and an inner circumference of the insertion groove 56 may have a shape of a curved surface corresponding to that of that of the tube 20 of the wire bundle 10.

As shown in FIG. 3, two insertion grooves 56 may be formed at intervals of 180° in a line in the wire insertion portion 52. Additionally, three insertion grooves may be formed at intervals of 120° as shown in FIG. 4, and one insertion groove may be formed in a center of the wire insertion portion 52 as shown in FIG. 5.

As shown in FIGS. 3, 6 and 6a, plurality of insertion grooves 56 may be recessed from a front and a side of the wire insertion portion 52. At least a portion of the wire bundle 10 may be exposed to the side of the wire insertion portion 52.

A first center point A of one of the insertion grooves 56 may be space apart from a second center point B of the wire insertion portion 52 by a predetermined distance D. A first radius R1 of the one of the insertion grooves may be smaller than the predetermined distance D. A sum of the first radius R1 and the predetermined distance D may be greater than a second radius R2 of the wire insertion portion 52.

When a third point at which a first circle corresponding to the one of the insertion grooves 56 and a second circle corresponding to the wire insertion portion 52 intersect is defined as a cross point C, and an angle ∠ABC may exceed 90 degrees.

In the present embodiment, the wire bundle 10 may be put in the tube 20 and inserted into the wire insertion portion 52, however, the wire bundle 10 may be twisted and inserted in the tube 20, rather than being putting in the tube 20.

Additionally, when only one wire bundle 10 is inserted in the wire insertion portion 52, as shown in FIG. 5, a size of the wire bundle 10 may be reduced, compared to when a plurality of wire bundles 10 are inserted, and accordingly it is advantageous to delicately clean a minute part of an implant.

The cover 70 may be connected to enclose an outer circumference of the wire insertion portion 52, to maintain a state in which the wire bundle 10 is inserted into the insertion groove 56. The cover 70 may have a hollow cylindrical shape, and may be connected by tight fitting by adjusting tolerance with the wire insertion portion 52, or may be connected to the wire insertion portion 52 using welding or soldering.

A step ring 54 may be formed in a lower part of the wire insertion portion 52. When the cover 70 is connected to the wire insertion portion 52 by a predetermined depth, the step ring 54 may prevent the cover 70 from sliding, and accordingly assembling of the cover 70 may be facilitated.

In the dental implant cleaning apparatus according to the first embodiment, the wire bundle 10 may be enclosed by the driver body 30 having elasticity, whereas in the dental implant cleaning apparatus according to the second embodiment, the cover 70 may desirably be formed of iron or stainless steel that does not have elasticity. The cover 70 may be formed of a rigid body, such as stainless steel, and accordingly strength of the dental implant cleaning apparatus may be improved.

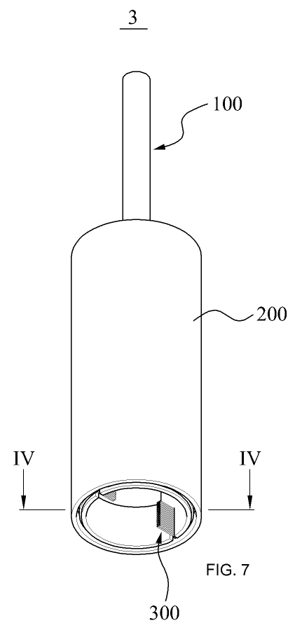

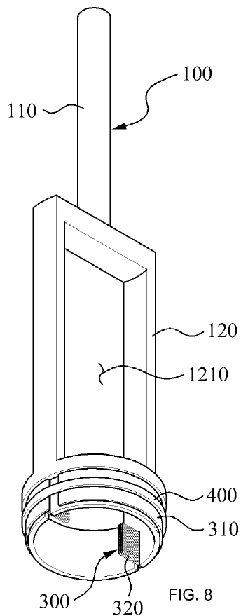

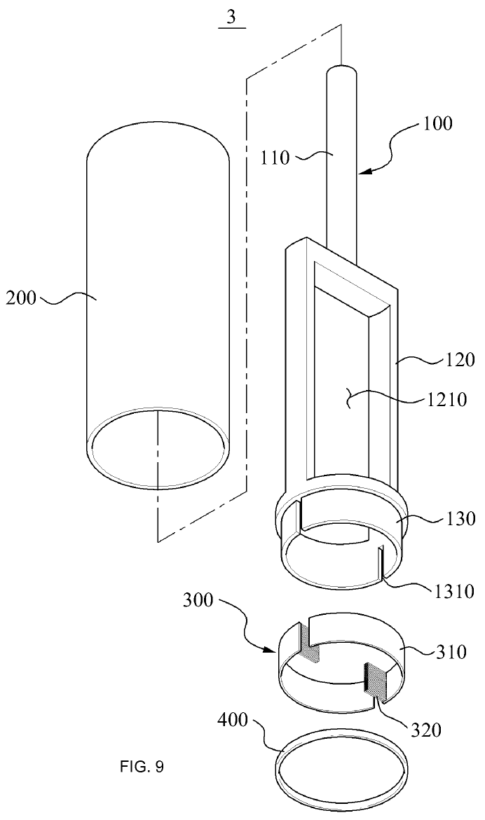

FIG. 7 is a perspective view of a dental implant cleaning apparatus according to a third embodiment of the present invention, FIG. 8 is a perspective view illustrating an internal structure of the dental implant cleaning apparatus according to the third embodiment of the present invention, and FIG. 9 is an exploded perspective view of the dental implant cleaning apparatus according to the third embodiment of the present invention.

Referring to FIGS. 7 through 9, a dental implant cleaning apparatus 3 according to the third embodiment of the present invention may include a driver 100, a cover 200, a brush 300, and an O-ring 400.

The driver 100 may be connected to a motor and the like, to receive provided rotatory power and to rotate the brush 300, or may be connected to an ultrasonic generator and the like, to receive provided vibration and to vibrate the brush 300.

The driver 100 may include a shaft 110, a driver body portion 120, and an implant receiving portion 130.

The shaft 110 may have a longitudinally extended cylindrical shape. The shaft 110 may provide a center of rotation of the driver 100, or may provide a center of vibration. The shaft 110 may be connected to a driving source, such as a motor and the like, and may receive driving force from the driving source.

The driver body portion 120 may be connected to the shaft 110, or may be formed integrally with the shaft 110. The driver body portion 120 may be formed in a shape of a flattened “U” in the present invention, however, there is no limitation to a shape of the driver body portion 120 in principle. However, since the driver body portion 120 is connected to the shaft 110 and is rotated (or vibrated), the driver body portion 120 may desirably be formed symmetrically about a line extending from the shaft 110.

The driver body portion 120 may transfer driving force of the shaft 110 to the implant receiving portion 130. A hollow portion 1210 may be formed to penetrate in the driver body portion 120. The hollow portion 1210 may be formed to reduce a weight of the driver body portion 120.

The implant receiving portion 130 may be included in an end of the driver body portion 120. The implant receiving portion 130 may be formed integrally with the driver body portion 120, or may be connected to the driver body portion 120. The implant receiving portion 130 may receive a dental implant therein, and may enclose the dental implant.

When the shaft 110 is rotated (or vibrated), the implant receiving portion 130 may be rotated or vibrated around the dental implant. Accordingly, the implant receiving portion 130 may desirably be formed in a hollow cylindrical shape.

The brush 300 may be closely connected to an outer circumference of the implant receiving portion 130. In the implant receiving portion 130, a wire penetration hole 1310 may be punched to enable penetration of a wire bundle 320 that is included in the brush 300 and that will be described later.

The brush 300 may include a brush body portion 310, and the wire bundle 320 included in an end of the brush body portion 310.

Since the brush body portion 310 may be in close contact with the outer circumference of the implant receiving portion 130, the brush body portion 310 may desirably have a thin curved surface. The brush body portion 310 may be formed by bending a thin plate. The brush body portion 310 may be attached onto the outer circumference of the implant receiving portion 130, by a welding scheme, a soldering scheme, and the like.

The brush body portion 310 may be formed of stainless steel with excellent strength and corrosion resistance.

The wire bundle 320 may protrude inwards from the end of the brush body 310. The wire bundle 320 may penetrate through the wire penetration hole 1310 formed in the implant receiving portion 130.

Accordingly, when the implant receiving portion 130, in which the dental implant is received, is rotated (or vibrated), the wire bundle 320 may come in contact with the dental implant, and may remove pollutants and the like that exist in the dental implant.

The wire bundle 320 may include a plurality of wires. The wires may be formed of bendy and flexible materials, or metal materials having elasticity. The wires may desirably be formed of shape-memory alloys, such as nickel-titanium (Ni—Ti) alloys, and the like.

The wire bundle 320 may be in direct contact with a dental implant, and may scrap food scraps, pollutants, and the like that exist in an outer circumference of the dental implant. Additionally, the wires may each have a diameter of about 1 nm, and may be very small and long. Accordingly, the wires may easily remove remnants that deeply exist in a screw thread of the dental implant, for example.

In addition, since the wire bundle 320 is formed of bendy and flexible materials, the outer circumference of the dental implant may be hardly damaged when the wires are in contact with the outer circumference of the dental implant.

To prevent the brush 300 from being separated from the implant receiving portion 130, the O-ring 400 may be used.

The O-ring 400 may enclose the brush body portion 310 and may apply pressure to the brush body portion 310, to prevent the brush 300 from being separated from the implant receiving portion 130, and to fix the brush 300 in the implant receiving portion 130.

The O-ring 400 may be formed of materials having elasticity, for example a rubber and the like, and may enclose an outer circumference of the brush body portion 310. However, when the brush 300 is already fixed in the implant receiving portion 130 by the welding scheme, the soldering scheme, and the like, the O-ring 400 may not be used.

The cover 200 may be connected to the driver 100, to enclose the driver body portion 120 and the implant receiving portion 130, after the brush 300 is fixed in the implant receiving portion 130 by the O-ring 400. The cover 200 may be formed in a hollow cylindrical shape, and there is no limitation to a scheme in which the cover 200 is connected to the driver 100. When the cover 200 is connected to the driver 100, the cover 200 may form an outer circumference of the dental implant cleaning apparatus 3, and may function to protect the driver body portion 120, the O-ring 400, and the implant receiving portion 130.

Hereinafter, an operation of the dental implant cleaning apparatus according to the present embodiment will be described.

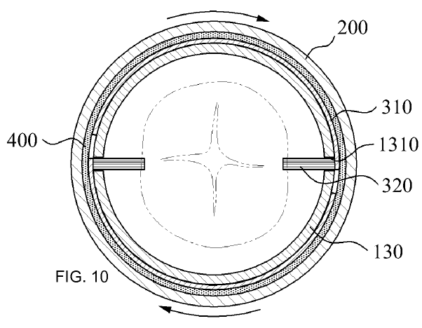

FIG. 10 is a diagram illustrating an operation state of the dental implant cleaning apparatus according to the third embodiment of the present invention.

Referring to FIG. 10, the wire bundle 320 may be enabled to penetrate through the wire penetration hole 1310 of the implant receiving portion 130, and the brush body portion 310 may be enabled to be in close contact with the outer circumference of the implant receiving portion 130.

The outer circumference of the brush body portion 310 may be enclosed by the O-ring 400, and the brush 300 may be fixed in the implant receiving portion 130.

In a state in which the brush 300 is fixed in the implant receiving portion 130, the cover 200 may be connected to the driver 100, to enclose the driver body portion 120 and the implant receiving portion 130.

Subsequently, the dental implant may be enabled to be located inside the implant receiving portion 130, and the shaft 110 may be enabled to be rotated (or vibrated).

When the shaft 110 is rotated (or vibrated), the wire bundle 320 protruding inwards from the implant receiving portion 130 may be rotated (or vibrated). The wire bundle 320 that is rotated (or vibrated) may come in contact with a circumference of the dental implant, so that the wire bundle 320 that is being rotated (or vibrated) may rapidly remove remnants stuck in an outer circumference of the dental implant.

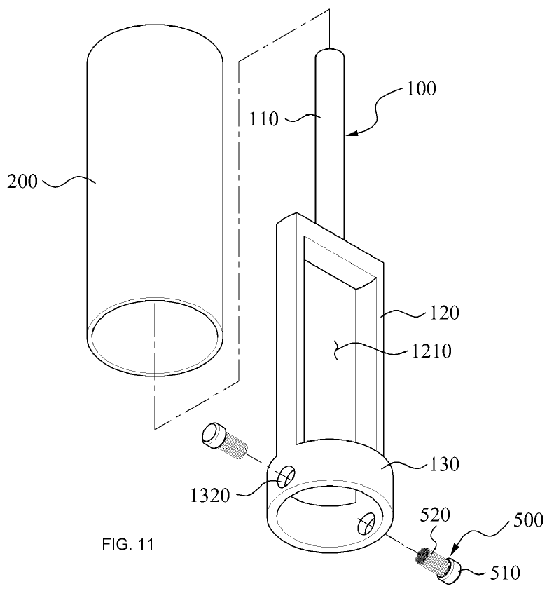

FIG. 11 is an exploded perspective view of a dental implant cleaning apparatus according to a fourth embodiment of the present invention.

The dental implant cleaning apparatus according to the fourth embodiment of the present invention may merely differ in a connection method and a structure of a brush from the dental implant cleaning apparatus according to the third embodiment of the present invention, and accordingly description of the other parts will be quoted from the third embodiment.

Referring to FIG. 11, a brush 500 according to the fourth embodiment of the present invention may include a brush body portion 510, and a wire bundle 520. The brush body portion 510 may enclose a part of the wire bundle 520. The brush body portion 510 may be formed in a cylindrical shape, and a space, into which the wire bundle 100 is to be inserted, may be formed in the brush body portion 510.

The brush body portion 510 may collect wires in the wire bundle 520 to prevent the wires from being dispersed. The brush body portion 510 may be formed of stainless steel with excellent strength and corrosion resistance.

The brush 500 may be fixed to be inserted in a wire penetration hole 1320 that is formed in an implant receiving portion 130 according to the present embodiment. The wire bundle 520 may protrude inwards from the implant receiving portion 130.

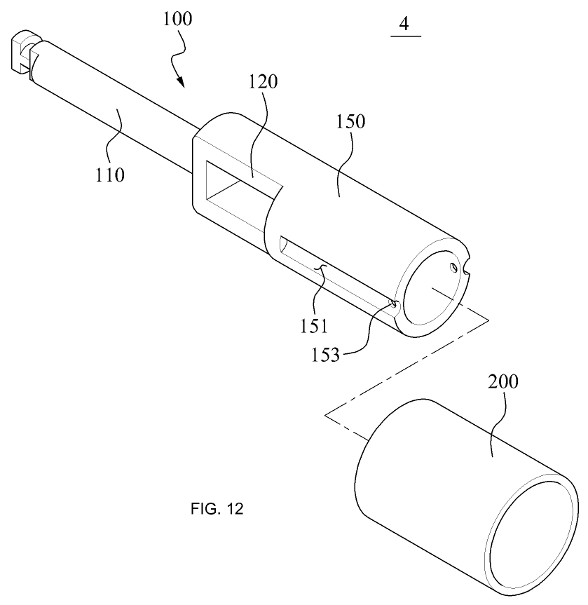

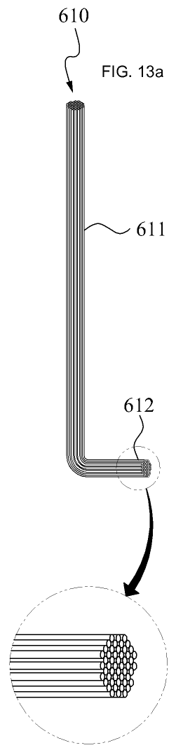

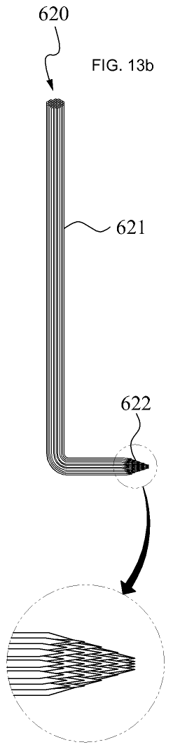

FIG. 12 is an exploded perspective view of a dental implant cleaning apparatus according to a fifth embodiment of the present invention, and FIGS. 13a and 13b are diagrams illustrating wires used in the dental implant cleaning apparatus according to the fifth embodiment of the present invention.

The dental implant cleaning apparatus according to the fifth embodiment of the present invention may merely differ in a connection method and a structure of a brush from the dental implant cleaning apparatus according to the third embodiment of the present invention, and accordingly description of the other parts will be quoted from the third embodiment.

Referring to FIGS. 12, 13a, and 13b, a dental implant cleaning apparatus 4 according to the fifth embodiment of the present invention may include a driver 100, a cover 200, and a brush 600.

The driver 100 may include a shaft 110, a driver body portion 120, and an implant receiving portion 150. The implant receiving portion 150 may be formed in a cylindrical shape to receive an implant therein, and a brush receiving groove 151, in which a part of the brush 600 is to be received, and a brush penetration hole 153, through which a part of the brush 600 penetrates, may be formed in a side of the implant receiving portion 150.

Additionally, the brush 600 may include a wire bundle including a plurality of Ni—Ti wires, and the brush 600 may be bent in the form of ‘L’ through a heat treatment. Since the brush 600 is bent in the form of ‘L’, an effect of facilitating assembling of the brush 600 may be obtained.

The brush 600 may include vertical bodies 611 and 621 received in the brush receiving groove 151 formed in the side of the implant receiving portion 150, and horizontal bodies 612 and 622 that are connected to the vertical bodies 611 and 621 in an approximately perpendicular manner. The horizontal bodies 612 and 622 may penetrate through the brush penetration hole 153, and ends of the horizontal bodies 612 and 622 may be in direct contact with an implant.

The brush 600 may be connected to the implant receiving portion 150, and then a circumference of the implant receiving portion 150 may be covered by the cover 200, and accordingly it is possible to prevent the brush 600 from being separated from the implant receiving portion 150.

The brush 600 may include a flat brush 610 and a conic brush 620, based on a shape of an end.

In the flat brush 610, an end of the horizontal body 612 in direct contact with an implant may be formed to be flat, and an end of each of Ni—Ti wires of the flat brush 610 may also be formed to be flat.

In the conic brush 620, an end of the horizontal body 622 in direct contact with an implant may be formed to be pointed, and an end of each of Ni—Ti wires of the conic brush 620 may also be formed to be pointed.

The conic brush 620 may more delicately clean a surface of an implant, since an end of each of a wire and a brush is formed in a shape of a cone. Accordingly, in normal times, the flat brush 610 may be used, and when more delicate cleaning is required, the conic brush 620 may be used instead of the flat brush 610.

1. A dental implant cleaning apparatus, comprising:
a wire bundle including a plurality of wires formed of flexible materials;
a tube provided separately of the wire bundle and constructed of a cylindrical shape to be fitted over the wire bundle whereby as a consequence of the fitting the tube is caused to enclose the wire bundle;
a wire insertion portion is provided in a form of a cylindrical shape;
an insertion groove having a curved inner surface matching that of a circle and the cylindrical shape of the tube, whereby an inner circumference of the insertion groove has a shape of the curved surface of the cylindrical shape thereby corresponding to that of the tube to accommodate insertion of the tube therein to enclose and hold the tube;
a cover being connected to enclose an outer circumference of the wire insertion portion, to maintain a state in which the wire bundle is inserted into the insertion groove; and
a step ring formed in a lower part of the wire insertion portion, the step ring enabling the cover be connected to the wire insertion portion by a predetermined depth,
wherein the insertion groove is recessed from a front and a side of the wire insertion portion,
wherein at least a portion of the wire bundle is exposed to the side of the wire insertion portion, and
wherein the wires are formed of shape-memory alloys.

2. The dental implant cleaning apparatus of claim 1, wherein the wires are formed of nickel-titanium (Ni—Ti) alloys.

3. The dental implant cleaning apparatus of claim 1, wherein a first center point A of the insertion groove is disposed at a predetermined distance from a second center point B of the wire insertion portion,
wherein a first radius of the insertion groove is smaller than the predetermined distance,
wherein a sum of the first radius and the predetermined distance is greater than a second radius of the wire insertion portion.

4. The dental implant cleaning apparatus of claim 3, wherein a third point at which a first circle corresponding to the insertion groove and a second circle corresponding to the wire insertion portion intersect is defined as a cross point C, and an angle ABC exceeds 90 degrees.

5. A dental implant cleaning apparatus, comprising:
a wire bundle including a plurality of wires formed of flexible materials;
a tube having a cylindrical shape with a space formed therein, whereby the tube is structured to accommodate insertion of the wire bundle therein, into the space, so as to enclose and hold the wire bundle; and
a driver connected to the wire bundle, to drive the wire bundle,
wherein the wires are formed of shape-memory alloys.

6. The dental implant cleaning apparatus of claim 5, wherein the wires are formed of nickel-titanium (Ni—Ti) alloys.

7. The dental implant cleaning apparatus of claim 5, wherein the tube is provided separately of the wire bundle and constructed to be fitted over the wire bundle thereby enabling the wire bundle to be put into the tube whereby as a consequence of the fitting the tube is caused to contact, encircle and enclose the wire bundle, whereby the tube encloses and holds the wire bundle so that by operation of its shape alone the tube is able to collect wires of the wire bundle and prevent the wires from being dispersed.

8. The dental implant cleaning apparatus of claim 5, further comprising a wire insertion portion, wherein one insertion groove is formed in a center of the wire insertion portion.

9. The dental implant cleaning apparatus of claim 5, wherein the driver enables the wire bundle to vibrate using an ultrasonic wave.

10. The dental implant cleaning apparatus of claim 5, wherein the driver comprises:
a wire insertion portion in which an insertion groove, in which the wire bundle is to be inserted, is formed;
a shaft connected to the wire insertion portion, to transfer power to the wire insertion portion; and
a cover connected to enclose an outer circumference of the wire insertion portion.

11. The dental implant cleaning apparatus of claim 10, wherein one insertion groove is formed in a center of the wire insertion portion.

12. The dental implant cleaning apparatus of claim 10, wherein two insertion grooves are formed at intervals of 180° in the wire insertion portion, or three insertion grooves are formed at intervals of 120°.
